(19) United States
(12) Patent Application Publication
(10) Pub. No.: US 2011/0206821 A1
(43) Pub. Date: Aug. 25, 2011

(54) Milk-Based Foods and Methods Related Thereto

(75) Inventor: Michael Costello, Pullman, WA (US)

(73) Assignee: WASHINGTON STATE UNIVERSITY RESEARCH FOUNDATION, Pullman, WA (US)

(21) Appl. No.: 13/002,151

(22) PCT Filed: Jul. 1, 2009
(86) PCT No.: PCT/US09/49459

§ 371 Date: Feb. 1, 2011

Related U.S. Application Data
(60) Provisional application No. 61/077,191, filed on Jul. 1, 2008.

(51) Int. Cl. A23J 1/20

(52) U.S. Cl. 426/580; 426/465; 426/466; 426/473; 426/442; 426/472

(57) ABSTRACT

The present invention provides milk-based foods that are optionally gluten free, vegetarian, low or lactose free, high protein, high calcium, and can be frozen. The foods herein can be used as a main course, a side dish, or as an ingredient in other foods, including foods that have gluten or meat components. Methods to make and use the invention are also provided.

### RELATED APPLICATIONS

None.

### STATEMENT REGARDING FEDERALLY SPONSORED RESEARCH

None.

### FIELD OF THE INVENTION

The present invention is in the field of food science, particularly dairy science. However, the ingredients and foods herein are useful as substitutes or enhancements for a variety of foods, such as breads, meats, pastas, RTE cereals, processed foods, etc. The present invention provides manufacturers, retailers and consumers with an opportunity increase vital nutrients, such as calcium and protein, over traditional choices.

### BACKGROUND OF THE INVENTION

New food products are always in demand, particularly those with an excellent taste profile, allow flexibility in recipes, and are easily stored. Moreover, for those people who choose a gluten free and/or vegetarian diet, foods which provide improved nutritional attributes over traditional foods, while providing eating experiences similar to traditional foods, are in demand.

Food items, such as bacon made from turkey or soybeans, turkey made from tofu, and an abundance of nutrition bars address the need in the market for a variety of protein sources. Vegetarian “meat-like” food items often include texturized vegetable protein, chopped vegetables and/or soy derivatives.

With regard to the bread category, chicken-based and soy-based bread products have been described. Moreover, milk proteins, including whey proteins, are common ingredients in mass-produced versions of food products.

There is also consumer demand for “gluten-free” foods. “Gluten free,” although defined for claiming purposes herein, is used by the food industry to describe foods or food components that traditionally contain proteins from wheat, rye or barley. Without gluten-type proteins, bread products, such as loaves, crackers and buns do not produce the cross-linked air pockets during rising, making the functionality of gluten proteins an important consideration in food development. However, in certain individuals foods having a gluten component cause a destructive immune response, and are thought to be linked to a progressive auto-immune disorder known generally as “celiac disease.”

Celiac disease is one of the most common and under-diagnosed genetic auto-immune conditions in the world. The disease is a multi-symptom, multi-system disorder, activated by eating gluten. It has been estimated that roughly 1% of the population of European and Indian ancestry has celiac disease. The number of diagnosed individuals is expected to increase as screening becomes more accurate and widespread.

One traditional northern European cheese is called “juusto” or “bread cheese” because it resembles toasted bread. Juusto is a relatively high moisture, medium fat, low acid (pH greater than 6), pressed curd cheese. It is made from whole milk that has been supplemented with calcium chloride, coagulated with enzymes, and cut into half-inch cubes. The cubes are agitated for approximately 20 minutes, drained, salted, and pressed at low pressure for around ten minutes, and increased pressure for almost two hours. The resulting block of cheese is then cut into slices that are approximately 1.25 inches thick and six inches square. The slices are baked or broiled to produce a crinkled black/brown exterior. Unbaked, block Juusto has approximately 48-50% moisture, 26-28% fat, 1 to 1.5% salt, with a pH of approximately 6.4. The baked cheese has approximately 42-44% moisture and 28-30% fat.

### SUMMARY OF THE INVENTION

The present invention provides milk-based, low acid and reduced moisture foods that are optionally low or lactose free, high protein, high calcium, and can be frozen. The foods herein can be used as a main course, a side dish, or as an ingredient in other foods, including foods that have gluten or meat components. Methods to make and use the invention are also provided.

The present invention specifically provides foods comprising milk-based curds having a pH 6 or greater and having 40% or less moisture by weight of the curds, preferably those with less than 30% moisture, most preferably those with less than 25% moisture.

Also provided are those foods as described above, wherein the curds have a non-cheese food shape, particularly those wherein said non-cheese food shape is selected from the group consisting of: meat, bread, tortilla, pasta, cracker, RTE cereal piece, cookie, fruit, candy, pastry, chip, pizza crust, and food bar.

Also provided are methods for producing the present foods, comprising: reducing the moisture of milk-based curds to 40% moisture or less by weight of the curds, wherein the milk-based curds have a pH 6 or greater.

In particular, methods for producing the present foods are provided, comprising a first step of pressing milk-based curds to form a larger pressed curd mass having a pH 6 or greater and less than 40% moisture, based on the total weight of the curd mass. Preferred are those methods as described, which further comprise a second step of chopping at least a portion of said curd mass. Also preferred are those which further comprise a third step of browning at least a portion of said chopped curd mass.

Also preferred, however, are methods as described, which alternatively comprise a second step of slicing a thin layer from at least a portion of said curd mass, and which also alternatively comprises a third step of browning at least a portion of at least one side of said sliced curd mass.

In another embodiment, there is provided a method to produce a food, comprising a first step of providing milk-based curds on a substrate so as to form a curd mass, the curd mass having a pH 6 or greater and less than 40% moisture, based on the total weight of the curd mass. In this embodiment, as in previous embodiments, there is provided an alternate second processing step selected from the group consisting of: chopping, shredding, ribboning, slicing, pressing, and dicing of said curd mass. After or before such second step is an optional step of browning at least a portion of at least one side of said curd mass.

In all embodiments, the curds may be optionally seasoned. Said seasoning may be selected from a group consisting of: beef; shrimp; fish; seafood; pork; chicken; bread; fruit; savory, sweet, spicy, and vegetable.

In all embodiments, nutrients may be added or removed. Said added nutrients may be selected from the group consisting of vitamins; minerals; carbohydrate; protein; fiber, and fat. Said removed nutrients may be selected from the group consisting of: vitamins; minerals; carbohydrate; protein; and fat.

In all embodiments, additional steps may be selected from group consisting of: brining, salting, sautéing, chopping, hydrating, pureeing, slicing, peeling, kneading, infusing, shredding, or frying.

Products made by the processes herein are also provided.

### Definitions

“Gluten-free” means that the food has less than 1% by weight of the food, of gluteinin, gliadinin, and/or fragments of glutenin and/or gliadinin.

“Moisture reduced” means any food having less than 40% moisture.

“Low acid” means having pH of greater than 6.

“Low moisture” means any food having less than 30% moisture

“Very low moisture” means any food having less than 25% moisture.

“Thin” means at least 0.5 mm but no more than 3 mm.

“Thick” means at least 4 mm.

“Milk-based” means sheep milk, cow milk, goat milk, water buffalo milk, and any mixture of those milks, including: milk that is reconstituted from components; milk that is skimmed; milk that is homogenized; milk that is fresh; or milk that is frozen.

“Dehydration” means any reduction of moisture content from the starting point, and not necessarily fully without moisture, although that condition is within this definition as well.

### DETAILED DESCRIPTION OF THE INVENTION

The final food product may take numerous shapes and sizes. For instance, for a pasta-shaped food product of the present invention, the curd may be manipulated to be shaped like spaghetti, fettuccini, fiore, fusilli, farfalle, lasagna, pipe, rotelli, rotini, cannelloni, macaroni, manicotti, penne, rigatoni, or ziti. In the meat-shaped embodiment, the shape may be similar a burger, tenderloin, steak, roast, shoulder, skirt, flank, ribs, club (triangular), sausage, etc. In the bread-shaped embodiment, the curd may take the shape of a slice, tortilla, baguette, ciabatti, brioche, roll, hamburger bun, hot dog bun, bagel, English muffin, donut, cinnamon roll, brownie, cookie, etc. In other words, the curds may be formed into virtually any shape, and seasoned in the manner of the food which it is imitating, providing possibilities to create nutritious options for many foods.

The present foods are naturally low in carbohydrates and can be made essentially free of lactose or other carbohydrates, and are entirely free of gluten. In particular embodiments, the foods herein provide low carbohydrate alternatives to traditional wheat-based products. In specific embodiments, foods are alternatives to traditional wheat-based products. In yet further embodiments, the foods provide carbohydrate alternatives to traditional wheat-based products. The foods are an outstanding source of calcium and high quality protein.

The foods are also convenient; they can be stored frozen and will retain inherent sensory attributes. Additionally, the foods can undergo multiple freeze-thaw cycles enabling a range of processing possibilities. For example, the foods can be manufactured at remote locations, frozen then integrated into other products and frozen again for sale to a consumer. For example, a pizza crust embodiment herein may be made at a particular location, frozen and transported to a second for further processing into a topped pizza, and re-frozen and distributed. Through a similar process a wide range of ready-made frozen foods containing the present foods can be produced. Examples include, but are not limited to pizza, lasagna, pastas, meat substitutes and burritos.

The present foods will be attractive to consumers seeking to reduce their carbohydrate intake, celiac disease sufferers who wish to enjoy a broader range of foods, consumers who wish to increase their calcium intake or consumers who wish the convenience of ready-made foods.

The present methods are useful to produce the present foods. In one example, the foods are produced by the direct coagulation of warm (80-125 degree F.) fresh milk by the use of chymosin, rennet or any other milk clotting enzyme that may be employed in the manufacture of enzyme-set cheese. The resulting curds are salted then pressed or spread in a slurry and baked. The nature and physical dimensions of the food to be imitated will define the necessary salting, pressing, spreading, and baking variables. The baked product may be frozen until final use.

The enzyme is introduced to the warm milk to produce a curd. Variables including the temperature, enzyme concentration and composition will influence both the curd formation time and affect the textural, functional or sensory attributes of the final product. In specific examples Ch. Hansen's double strength Chymax Extra®, Danisco Rennet®, Chymostar®, Marzyme® are employed; however, any other single or double strength natural calf rennet, plant-derived or microbial analog may be utilized. In specific embodiments, 1.4 fluid ounces or double strength commercial milk clotting enzyme per 1000 pounds of milk is used, although more or less may be added to either accelerate the process or to affect the textural, functional or sensory attributes of the final product. In addition, higher temperatures (up to 120 degrees F.) may be used to accelerate the procedure or to modify the textural, functional or sensory attributes of the final product.

After the treated milk gels to form a uniform and continuous curd with a consistency that approximates custard or Jello®, that curd is cut into approximately 1/2 inch cubes, although larger (1 inch) or smaller (¼ inch) cubes may also be used depending upon the moisture content, textural, functional or sensory qualities that one is seeking to achieve in the final product. Larger cubes will retain more moisture, while cutting into smaller curds will produce a drier final product.

The newly cut cubes are ideally and optionally permitted to sit quiescently in the whey for about five minutes to strengthen, firm and shrink as they are very fragile immediately after cutting and will shatter if agitated immediately after cutting. Failure to permit this “healing” will not affect the quality of the final product, but will adversely impact yield.

At the conclusion of the healing stage, the curds and whey are ideally cooked with gentle agitation for 20 to 60 minutes at 98 degrees F. although longer or shorter agitation periods and higher or lower temperatures may be employed to influence the final moisture content, textural, functional or sensory qualities of the final product. Cooking for up to an hour at 90 degree F. will yield a somewhat drier product, while cooking for 8-10 minutes at up to 120 degrees F. will yield a moister product.

Coagulating enzyme concentrations may also be manipulated to influence preparation time and product attributes. Enzyme concentrations may be doubled or even quadrupled to accelerate setting. Doing so will result in a drier product that will be more appropriate for making the pasta analog.

The textural, functional or sensory attributes of the product may be modified by the addition of calcium chloride or stabilizers to the milk prior to introduction of the enzyme. Calcium chloride will increase the cross linking between the proteins and will toughen the product should the manufacturer wish a firmer texture.

Adding gums or stabilizers, such as gelatin, pectin, starch, carboxymethylcellulose, guar gum, carrageenan, gum arabic, or other vegetable gum or proprietary gum or stabilizer will increase water binding capacity, and will soften the product while preserving or even increasing tensile strength. Such additions may be employed to create a pasta food with a more “al dente” firmness or a pliable tortilla that will roll into a burrito.

At the conclusion of the cooking step, the whey is drained and curds are salted and may be flavored if desired. Salt contributes to the flavor, but also influences the texture by displacing calcium from the protein matrix. A salt concentration of 1.2% in the final baked product yields a full flavored product with satisfactory textural properties for a pizza crust. More may be added to suit the tastes of the consumer. A final salt concentration as low as 0.5% may be indicated for pasta or a tortilla food. As the flavorings are added to potentiate the flavor of the milk derived food to match the sensory characteristics of the wheat-based product for which it is to be food, the flavoring quantities and composition are determined entirely by the desired sensory attributes desired in the final product.

At this point, the curds may be placed into a hoop of the appropriate dimensions for a pizza crust, patty, tortilla or pasta, they may be fed into an extruder that will deliver the product in the appropriate size or shape, or they may be diverted to form a slurry for the manufacture of a meat patty alternative.

The curds intended for a pizza crust are typically pressed for 20 minutes at 20 psi, then for another 80 minutes at 40 psi. These pressures and times may be modified to the manufacturer's specifications and certainly will be different if block forming towers are employed. Higher pressures require less time for pressing. As this is a low acid product, it is best to press no longer than 2 hours. The curds will flow together under the pressure and form a single mass.

Once the cheese curds have been adequately pressed, so that they have been pressed into a cohesive mass that can be handled without disintegrating, the resulting cheese should be thinly sliced and baked until the proper texture and appearance and sensory qualities are achieved. In an impinger, or conveyor belt equipped pizza oven set at 525 degrees F., the time is approximately 6 minutes, although it could be more or less depending upon the thickness of the crust, the performance of the oven or the desired attributes of the final product. When using an impinger oven, temperatures significantly higher than 525 degrees F. and cooking times longer than 6 minutes will yield a very dark product. Curds diverted for manufacture of the pasta food should be spread in a thin slurry in either a pan or a conveyor belt and baked in an impinger oven or other oven that will maintain an even temperature. Using the impinger oven will accelerate the baking procedure. Milk intended for the manufacture of the pasta food should be pre-treated using membrane filtration or other means to remove most of the reducing sugar as residual sugar will impart a brown color upon the final product during baking.

The inventive pizza crust and/or pasta can be formed into any shape and ideally frozen until further use, although dehydration and/or refrigeration is acceptable as well.

The textural, functional or sensory qualities of the final product may also be modified through the addition of skim milk powder, whey powder, or fat from any source to the milk prior to the addition of the enzyme. Skim milk powder will yield a tougher, drier product. Denatured whey powder addition will yield a moister, softer product. Fat will contribute flavor and will produce a softer, more compliant product.

Carbohydrate is not essential to the product and its removal might be desirable to make the product more attractive to people who are lactose intolerant or are seeking to minimize carbohydrates in their diet. Removal of carbohydrate is also desirable to prevent browning during the baking step. This is particularly important in the manufacture of pasta analog as pasta is typically pale. The product may be made carbohydrate free using membrane filtration of the milk prior to the addition of enzyme.

If the milk is pre-treated to remove all sugar, a small amount of a reducing sugar should be added back to milk intended for the pizza crust manufacture so that a brown, bread-like color will appear upon baking. This will not be desirable if the product is to be used as a pasta replacement.

In addition, cooking times and temperatures may be manipulated to affect the final moisture content and therefore the textural properties of the product. Longer bake times at lower temperatures will yield a drier product, while combining higher temperatures and shorter cook times will produce as moister product.

Measuring pH may be accomplished according to known methods, although use of a spear tip pH meter is easiest and reliable (Nelson Jameson, of WI is a supplier).

Measuring moisture content is accomplished according to known methods. In one method, a sample is weighed prior to dehydration, then completely dehydrated in an oven, and weighed after dehydration. The difference between the first and second weight is the weight of the moisture driven off. Percent moisture in the sample is determined by dividing the weight of the moisture driven off by the total sample weight prior to dehydration and multiplied by 100.

### EXAMPLES

### Example 1

### Producing Cheese Curds

Pasteurized milk is tempered to about 90 degrees Fahrenheit. Double strength enzyme is introduced at a rate that will produce a curd in approximately 30 minutes, or 1.4 ounces per 1000 pounds of milk. The mass is cut into approximately ¼ inch cubes and allowed to heal for approximately 5 minutes. The cubes are cooked for approximately 20 minutes at approximately 98 degrees F. The whey is drained and curds are salted to a final salt concentration of 1% in the curds or 1.2% in the final product. The resulting curds have developed little to no lactic acid during the process.

### Example 2

### Finishing Method For a Hamburger Substitute

Curds of Example 1 are seasoned with garlic, onion, sweet or hot peppers, sun-dried tomatoes, herbs, liquid smoke or seasoned with other flavorings, and placed into a cylindrical hoop approximately 5 inches in diameter and approximately 36 inches in height, and pressed for approximately 20 minutes at approximately 20 psi, then for another 80 minutes at 40 psi. The cheese from the mold or hoop is cut to 1 inch in thickness and baked in an impinger oven at 525 degrees F. for about six minutes. The baked product has 40% moisture, and pH 6 or greater.

### Example 3

### Alternate Finishing Method for Hamburger Substitute

A slurry of salted and seasoned curds and whey as described in Example 1 are placed in a baking pan 1 to 2″ deep and placed in a 525 degree F. until browned. Five inch in diameter patties are cut from the baked cheese. The baked product has 45% moisture.

### Example 4

### Alternative Method for Hamburger Substitute

The salted, seasoned curds may be fed into a heated extruder that will deliver a product of the proper diameter (4-5 inches) that may then be sliced to the desired thickness.

### Example 5

### Finishing Method for Ground Beef Substitute

Either products of Example 2, 3 or 4 are cooled and/or frozen, and crumbled.

### Example 6

### Finishing Method for Lasagna, Fettuccini or Spaghetti Substitute

Curds of Example 1 are seasoned and placed into a rectangular hoop approximately ten inches in length and approximately 20 inches on each side. The hoop is pressed for approximately 20 minutes at approximately 20 psi, then for another 80 minutes at 40 psi. The cheese from the mold or hoop is cut to 1.5 mm slices and baked in an impinger oven at 525 degrees F. for about six minutes. The baked product is sliced into ribbons of a width that will approximate lasagna, fettuccini or spaghetti and has a moisture content of approximately 25%.

### Example 7

### Alternate Finishing Method for Making Lasagna, Fettuccini or Spaghetti

Cheese curds from example 1 are fed into a heated extruder engineered to deliver a product of a shape convenient for further manipulation, probably a rectangle. As the product emerges from the extruder, it is sliced approximately 1.5 mm thick and baked in an impinger over at 525 degrees for about six minutes. The baked product is sliced into ribbons of a width that will approximate lasagna, fettuccini or spaghetti and has a moisture content of approximately 25%.

### Example 8

### Finishing Method for Bread Substitute

Curds of Example 1 are seasoned and placed into a rectangular hoop approximately ten inches in length and approximately 20 inches on each side. The hoop is pressed for approximately 20 minutes at approximately 20 psi, then for another 80 minutes at 40 psi. The cheese from the mold or hoop is cut to 2 mm slices and baked in an impinger oven at 525 degrees F. for about six minutes. The baked product is sliced into ribbons and has a moisture content of approximately 30%.

### Example 9

### Finishing Method for Pizza Crust

Cheese curds of Example 1 are placed into a cylindrical hoop of a diameter that will yield a pizza crust of the desired size (small, medium, large, personal, etc.) and 36 inches in height. The hoop is pressed for approximately 20 minutes at approximately 20 psi, then for another 80 minutes at 40 psi. The cheese from the mold is cut to 4-5 mm slices and baked in an impinger oven at 525 degrees F. for about 6 minutes. The baked product is removed to the freezer until further processing and has a moisture content of approximately 35%.

### Example 10

### Alternate Finishing Method for Pizza Crust

Cheese curds of Example 1 are fed into a heated extruder engineered to deliver a cylindrical cohesive mass of the diameter desired for the final product (small, medium, large, personal, etc). As the mass emerges from the extruder, it is cut to 4-5 mm slices and baked in an impinger oven at 525 degrees F. for about 6 minutes. The baked product is removed to the freezer until further processing and has a moisture content of approximately 35%.

We claim:

1. A food comprising: milk-based curds having a pH 6 or greater and having 40% or less moisture by weight of the curds.

2. A food of claim 1, wherein said curds have less than 30% moisture.

3. A food of claim 2, wherein said curds have less than 25% moisture.

4. A food of claim 1, wherein said milk-based curds have a non-cheese food shape.

5. A food of claim 1, wherein said non-cheese food shape is selected from the group consisting of: meat, bread, tortilla, pasta, cracker, RTE cereal piece, cookie, fruit, candy, pastry, chip, pizza crust, and food bar.

6. A method for producing a food, comprising: reducing the moisture of milk-based curds to 40% moisture or less by weight of the curds, wherein the milk-based curds have a pH 6 or greater.

7. A method for producing a food, comprising: a first step of pressing milk-based curds to form a larger pressed curd mass having a pH 6 or greater and less than 40% moisture, based on the total weight of the curd mass.

8. A method of claim 7, which further comprises a second step of chopping at least a portion of said curd mass.

9. A method of claim 8, which further comprises a third step of browning at least a portion of said chopped curd mass.

10. A method of claim 7, which further comprises a second step of slicing a thin layer from at least a portion of said curd mass.

11. A method of claim 10, which further comprises a third step of browning at least a portion of at least one side of said sliced curd mass.

12. A method for producing a food, comprising: a first step of providing milk-based curds on a substrate so as to form a curd mass, the curd mass having a pH 6 or greater and less than 40% moisture, based on the total weight of the curd mass.

13. A method of claim 12, which further comprises a second processing step selected from the group consisting of: chopping, shredding, ribboning, slicing, pressing, and dicing of said curd mass.

14. A method of claim 12, which further comprises a second step of browning at least a portion of at least one side of said curd mass.

15. A method of claim 6, which further comprises seasoning said curds.

16. A method of 15, wherein said seasoning is selected from a group consisting of: beef; shrimp; fish; seafood; pork; chicken; bread; fruit; savory, sweet, spicy, and vegetable.

17. A method of claim 6, which further comprises a step of adding nutrients.

18. A method of claim 17, wherein said nutrients are selected from the group consisting of: vitamins; minerals; carbohydrate; protein; fiber, and fat.

19. A method of claim 6, which further comprises a step of removing nutrients.

20. A method of claim 19, wherein said nutrients are selected from the group consisting of: vitamins; minerals; carbohydrate; protein; and fat.

21. A method of claim 6, which further comprises a step selected from the group of: brining, salting, sautéing, chopping, hydrating, pureeing, slicing, peeling, kneading, infusing, shredding, or frying.

22. A product made by the process of claim 6.
